(19) United States
(12) Patent Application Publication
(10) Pub. No.: US 2024/0284249 A1
(43) Pub. Date: Aug. 22, 2024

(54) METHODS AND APPARATUSES FOR REPORTING DATA DELAY INFORMATION IN WIRELESS COMMUNICATION SYSTEMS

(71) Applicant: FG Innovation Company Limited, Tuen Mun (HK)

(72) Inventors: CHIA-HUNG WEI, Taipei (TW); TZU-WEN CHANG, Taipei (TW)

(21) Appl. No.: 18/434,109

(22) Filed: Feb. 6, 2024

Related U.S. Application Data
(60) Provisional application No. 63/446,705, filed on Feb. 17, 2023.

(51) Int. Cl. H04W 28/02; H04W 72/231

(52) U.S. Cl. CPC H04W 28/0278; H04W 72/231

(57) ABSTRACT

Methods and apparatuses for reporting and managing data delay information are provided. The method includes receiving a first threshold for a first Logical Channel Group (LCG) from a Base Station (BS) and transmitting a particular Medium Access Control (MAC) Control Element (CE) to the BS in a case that a first condition associated with the first threshold is met. The particular MAC CE carries, at least, a first data delay information value for the first LCG and a first buffer size value indicating an amount of first Uplink (UL) data that is associated with the first condition and buffered in the first LCG.

### CROSS-REFERENCE TO RELATED APPLICATION(S)

The present disclosure claims the benefit of and priority to U.S. Provisional Patent Application Ser. No. 63/446,705, filed on Feb. 17, 2023, entitled “BUFFER STATUS REPORT PROCEDURE FOR XR,” the content of which is hereby incorporated herein fully by reference into the present disclosure for all purposes.

### FIELD

The present disclosure is related to wireless communication and, more specifically, to methods and apparatuses for reporting data delay information in a wireless communication system.

### BACKGROUND

Various efforts have been made to improve different aspects of wireless communication for cellular wireless communication systems, such as 5th Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). As the demand for radio access continues to increase, however, there exists a need for further improvements in the art.

### SUMMARY

The present disclosure is related to methods and apparatuses for reporting data delay information in a wireless communication system.

According to a first aspect of the present disclosure, a method performed by a User Equipment (UE) for reporting data delay information is provided. The method includes receiving a first threshold for a first Logical Channel Group (LCG) from a Base Station (BS) and transmitting a particular Medium Access Control (MAC) Control Element (CE) to the BS in a case that a first condition associated with the first threshold is met. The particular MAC CE carries, at least, a first data delay information value for the first LCG and a first buffer size value indicating an amount of first Uplink (UL) data that is associated with the first condition and buffered in the first LCG.

In some implementations of the first aspect of the present disclosure, the method further includes determining a group of data delay information values for one or more Logical Channels (LCHs) associated with the first LCG; and selecting a smallest data delay information value from the group of data delay information values as the first data delay information value for the first LCG.

In some implementations of the first aspect of the present disclosure, the first UL data is buffered in the one or more LCHs corresponding to the group of data delay information values from which the first data delay information value is selected, and the first condition includes the first data delay information value being equal to or less than the first threshold.

In some implementations of the first aspect of the present disclosure, the method further includes receiving a second threshold for a second LCG from the BS; and transmitting the particular MAC CE to the BS further in a case that a second condition associated with the second threshold is met. The particular MAC CE further carries a second data delay information value for the second LCG and a second buffer size value indicating an amount of second UL data that is associated with the second condition and buffered in the second LCG.

In some implementations of the first aspect of the present disclosure, the method further includes prioritizing the transmission of the particular MAC CE over a transmission of a Buffer Status Report (BSR) MAC CE when the first condition or the second condition is met. The BSR MAC CE includes a third buffer size value indicating an amount of third UL data buffered in the first LCG or the second LCG.

In some implementations of the first aspect of the present disclosure, the method further includes receiving one or more mapping tables from the BS; selecting a mapping table from the one or more mapping tables; and applying the mapping table to determine the first data delay information value.

In some implementations of the first aspect of the present disclosure, selecting the mapping table from the one or more mapping tables includes selecting the mapping table from the one or more mapping tables according to at least one of: a number of LCGs for which the UE is required to trigger data delay information reporting, and a number of UL resources to be used to transmit the particular MAC CE.

In some implementations of the first aspect of the present disclosure, the first LCG is associated with extended Reality (XR) traffic.

In some implementations of the first aspect of the present disclosure, the particular MAC CE further carries a presence indicator indicating a presence of the first data delay information value in the particular MAC CE.

According to a second aspect of the present disclosure, a User Equipment (UE) for reporting data delay information is provided. The UE includes at least one processor and at least one memory coupled to the at least one processor. The at least one memory stores one or more computer-executable instructions that, when executed by the at least one processor, cause the UE to receive a first threshold for a first Logical Channel Group (LCG) from a Base Station (BS) and to transmit a particular Medium Access Control (MAC) Control Element (CE) to the BS in a case that a first condition associated with the first threshold is met. The particular MAC CE carries, at least, a first data delay information value for the first LCG and a first buffer size value indicating an amount of first Uplink (UL) data that is associated with the first condition and buffered in the first LCG.

In some implementations of the second aspect of the present disclosure, the one or more computer-executable instructions, when executed by the at least one processor, further cause the UE to determine a group of data delay information values for one or more Logical Channels (LCHs) associated with the first LCG; and select a smallest data delay information value from the group of data delay information values as the first data delay information value for the first LCG.

In some implementations of the second aspect of the present disclosure, the first UL data is buffered in the one or more LCHs corresponding to the group of data delay information values from which the first data delay information value is selected, and the first condition includes the first data delay information value being equal to or less than the first threshold.

In some implementations of the second aspect of the present disclosure, the one or more computer-executable instructions, when executed by the at least one processor, further cause the UE to receive a second threshold for a second LCG from the BS; and transmit the particular MAC CE to the BS further in a case that a second condition associated with the second threshold is met. The particular MAC CE further carries a second data delay information value for the second LCG and a second buffer size value indicating an amount of second UL data that is associated with the second condition and buffered in the second LCG.

In some implementations of the second aspect of the present disclosure, the one or more computer-executable instructions, when executed by the at least one processor, further cause the UE to prioritize the transmission of the particular MAC CE over a transmission of a Buffer Status Report (BSR) MAC CE when the first condition or the second condition is met. The BSR MAC CE includes a third buffer size value indicating an amount of third UL data buffered in the first LCG or the second LCG.

In some implementations of the second aspect of the present disclosure, the one or more computer-executable instructions, when executed by the at least one processor, further cause the UE to receive one or more mapping tables from the BS; select a mapping table from the one or more mapping tables; and apply the mapping table to determine the first data delay information value.

In some implementations of the second aspect of the present disclosure, selecting the mapping table from the one or more mapping tables includes selecting the mapping table from the one or more mapping tables according to at least one of: a number of LCGs for which the UE is required to trigger data delay information reporting, and a number of UL resources to be used to transmit the particular MAC CE.

In some implementations of the second aspect of the present disclosure, the first LCG is associated with extended Reality (XR) traffic.

In some implementations of the second aspect of the present disclosure, the particular MAC CE further carriers a presence indicator indicating a presence of the first data delay information value in the particular MAC CE.

According to a third aspect of the present disclosure, a Base Station (BS) for managing data delay information in a wireless communication system is provided. The BS includes at least one processor and at least one memory coupled to the at least one processor. The at least one memory stores one or more computer-executable instructions that, when executed by the at least one processor, cause the BS to transmit a first threshold for a first Logical Channel Group (LCG) to a User Equipment (UE), enabling the UE to transmit a particular Medium Access Control (MAC) Control Element (CE) in a case that a first condition associated with the first threshold is met, and to receive the particular MAC CE from the UE. The particular MAC CE carries, at least, a first data delay information value for the first LCG and a first buffer size value indicating an amount of first Uplink (UL) data that is associated with the first condition and buffered in the first LCG.

In some implementations of the third aspect of the present disclosure, the one or more computer-executable instructions, when executed by the at least one processor, further cause the BS to transmit a second threshold for a second LCG to the BS, enabling the UE to transmit the particular MAC CE further in a case that a second condition associated with the second threshold is met. The particular MAC CE further carries a second data delay information value for the second LCG and a second buffer size value indicating an amount of second UL data that is associated with the second condition and buffered in the second LCG.

In some implementations of the third aspect of the present disclosure, the first LCG is associated with extended Reality (XR) traffic.

In some implementations of the third aspect of the present disclosure, the particular MAC CE further carries a presence indicator indicating a presence of the first data delay information value in the particular MAC CE.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a flowchart of a method for reporting data delay information in a wireless communication system, according to an example implementation of the present disclosure.

FIG. 2 is a flowchart of a method for determining the first data delay information value for the first LCG, according to an example implementation of the present disclosure.

FIG. 3 is a flowchart of a method for utilizing mapping table(s) to determine the first data delay information value, according to an example implementation of the present disclosure.

FIG. 4 is a block diagram illustrating a node for wireless communication, according to an example implementation of the present disclosure.

### DESCRIPTION

Some of the abbreviations used in this disclosure include:

| Abbreviation | Full name |
|---|---|
| 3GPP | 3^{rd} Generation Partnership Project |
| 5G | 5^{th} Generation |
| 5GC | 5G Core |
| ACK | Acknowledgement |
| AN-PDB | Access Network Packet Delay Budget |
| AS | Access Stratum |
| ASN.1 | Abstract Syntax Notation One |
| BFRQ | Beam Failure Recovery Request |
| BS | Base Station |
| BSR | Buffer Status Report |
| BWP | Bandwidth Part |
| C-RNTI | Cell Radio Network Temporary Identifier |
| CA | Carrier Aggregation |
| CAG | Closed Access Group |
| CG | Configured Grant |
| CJT | Coherent Joint Transmission |
| CN | Core Network |
| CN-PDB | Core Network Packet Delay Budget |
| CORESET | Control Resource Set |
| CRC | Cyclic Redundancy Check |
| CSI | Channel State Information |
| CSI-RS | Channel State Information Reference Signal |
| CS-RNTI | Configured Scheduling Radio Network |
| | Temporary Identifier |
| CSS | Common Search Space |
| CU | Central Unit |
| DAPS | Dual Active Protocol Stack |
| DC | Dual Connectivity |
| DCI | Downlink Control Information |
| DG | Dynamic Grant |
| DI | Delay Information |
| DL | Downlink |
| DL-SCH | Downlink Shared Channel |
| DMRS | Demodulation Reference Signal |
| DR | Delay Report |
| DRB | Data Radio Bearer |
| DTCH | Dedicated Traffic Channel |
| DU | Distributed Unit |
| ETSI | European Telecommunications Standards Institute |
| E-UTRA | Evolved Universal Terrestrial Radio Access |
| EN-DC | E-UTRA NR Dual Connectivity |
| EPC | Evolved Packet Core |
| eMBB | Enhanced Mobile BroadBand |
| eMTC | Enhanced Machine Type Communication |
| eNB | Evolved Node B |
| FDD | Frequency Division Duplexing |
| FR | Frequency Range |
| FR1 | Frequency Range 1 |
| FR2 | Frequency Range 2 |
| GEO | Geostationary Equatorial Orbit |
| gNB | Next Generation Node B |
| GNSS | Global Navigation Satellite System |
| GW | Gateway |
| HARQ | Hybrid Automatic Repeat Request |
| HO | Handover |
| FR | Frequency Range |
| IAB | Integrated Access and Backhaul |
| ID | Identity |
| IE | Information Element |
| IoT | Internet of Things |
| ITS | Intelligent Transportation System |
| ITU | International Telecommunication Union |
| L1 | Layer 1 |
| L2 | Layer 2 |
| L3 | Layer 3 |
| LAN | Local Area Network |
| LCH | Logical Channel |
| LCID | Logical Channel Identity |
| LEO | Low Earth Orbit |
| LTE | Long Term Evolution |
| MAC | Medium Access Control |
| MAC CE | MAC Control Element |
| MCG | Master Cell Group |
| MIB | Master Information Block |
| MIMO | Multi-Input Multi-Output |
| mMTC | Massive Machine Type Communications |
| MN | Master Node |
| MTC | Machine Type Communication |
| NACK | Negative Acknowledgement |
| NAS | Non-Access Stratum |
| NB-IoT | Narrow Band Internet of Things |
| NDI | New Data Indicator |
| NPN | Non-Public Network |
| NR | New Radio |
| NR-U | NR Unlicensed |
| NTN | Non-Terrestrial Network |
| PBCH | Physical Broadcast Channel |
| PCell | Primary Cell |
| PCI | Physical Cell Identity |
| PDB | Packet Delay Budget |
| PDCCH | Physical Downlink Control Channel |
| PDCP | Packet Data Convergence Protocol |
| PDSCH | Physical Downlink Shared Channel |
| PDU | Protocol Data Unit |
| PHY | Physical |
| PLMN | Public Land Mobile Network |
| PNI-NPN | Public Network Integrated Non-Public Network |
| PRACH | Physical Random Access Channel |
| PSDB | PDU Set Delay Budget |
| PUCCH | Physical Uplink Control Channel |
| PUSCH | Physical Uplink Shared Channel |
| QoS | Quality of Service |
| RA | Random Access |
| RACH | Random Access Channel |
| RAN | Radio Access Network |
| RAR | Random Access Response |
| RAT | Radio Access Technology |
| RF | Radio Frequency |
| RLC | Radio Link Control |
| RS | Reference Signal |
| RLF | Radio Link Failure |
| RSTD | Reference Signal Time Difference Measurement |
| RNTI | Radio Network Temporary Identifier |
| RO | RACH Occasion |
| RRC | Radio Resource Control |
| RS | Reference Signal |
| RSRP | Reference Signal Received Power |
| RSRQ | Reference Signal Receiving Quality |
| SCell | Secondary Cell |
| SCG | Secondary Cell Group |
| SDT | Small Data Transmission |
| SI | System Information |
| SIB | System Information Block |
| SL | Sidelink |
| SLIV | Start and Length Indicator Value |
| SN | Secondary Node |
| SNPN | Stand-alone Non-Public Network |
| SpCell | Special Cell |
| SR | Scheduling Request |
| SRB | Signaling Radio Bearer |
| SSB | Synchronization Signal Block |
| SUL | Supplementary Uplink |
| TA | Timing Advance |
| TAG | Timing Advance Group |
| TAT | Time Alignment Timer |
| TB | Transport Block |
| TCI | Transmission Configuration Indication |
| TDD | Time Division Duplexing |
| TN | Terrestrial Network |
| TRP | Transmission Reception Point |
| TRS | Tracking Reference Signal |
| TS | Technical Specification |
| TX | Transmission |
| UCI | Uplink Control Information |
| UE | User Equipment |
| UL | Uplink |
| UL-CG | Uplink-Configured Grant |
| UPF | User Plane Function |
| URLLC | Ultra-Reliable and Low-Latency Communications |
| USIM | Universal Subscriber Identity Module |
| USS | UE-specific Search Space |
| V2X | Vehicle-to-Everything |
| VSAT | Very Small Aperture Terminal |
| XR | Extended Reality |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For consistency and ease of understanding, like features may be identified (although, in some examples, not illustrated) by the same numerals in the drawings. However, the features in different implementations may be different in other respects and shall not be narrowly confined to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “in one implementation,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using a plurality of cells forming the RAN. The BS supports the operations of the cells. Each cell is operable to provide services to at least one UE within its radio coverage.

Each cell (often referred to as a serving cell) provides services to serve one or more UEs within its radio coverage such that each cell schedules the DL and optionally UL resources to at least one UE within its radio coverage for DL and optionally UL packet transmissions. The BS may communicate with one or more UEs in the radio communication system via the plurality of cells.

A cell may allocate sidelink (SL) resources for supporting Proximity Service (ProSe) or Vehicle to Everything (V2X) service. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), including the SpCell and optionally one or more Secondary Cells (SCells). An SCG may refer to a group of serving cells associated with the Secondary Node (SN), including the SpCell and optionally one or more SCells.

As previously disclosed, the frame structure for NR supports flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes are considered for NR, specifically Low-Density Parity-Check (LDPC) code and Polar Code. The coding scheme adaption may be configured based on channel conditions and/or service applications.

At least DL transmission data, a guard period, and UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more than two of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

“A and/or B” in the present disclosure may refer to either A or B, both A and B, or at least one of A and B.

The terms, definitions, and abbreviations included in the present disclosure are either sourced from existing documents (such as those from ETSI, ITU, or other sources) or newly created by experts from 3GPP whenever there was a need for precise vocabulary.

Examples of some selected terms in the present disclosure are provided as follows.

The RS ID mentioned in the present disclosure may be substituted by another ID that either explicitly or implicitly indicates, to the gNB, the new beam.

The DL RRC message, as referred to in the present disclosure, may include, but is not limited to, an RRC reconfiguration message (or the RRCReconfiguration IE), an RRC resume message (or “RRCResume” IE), an RRC re-establishment message (or the RRCReestablishment IE), an RRC setup message (or the RRCSetup IE), or any other DL unicast RRC message.

The phrase “a specific configuration is per UE configured” or “a specific configuration is configured for a UE” may mean that the specific configuration may be included in, but is not limited to, a DL RRC message.

The phrase “a specific configuration is per cell group configured” or “a specific configuration is configured for a cell group” may mean that the specific configuration may be included in, but is not limited to, a cell group configuration (or the CellGroupConfig IE), a MAC cell group configuration (or the MAC-CellGroupConfig IE), or a physical cell group configuration (or the PhysicalCellGroupConfig IE).

The phrase “a specific configuration is per serving cell configured” or “a specific configuration is configured for a serving cell” may mean that the specific configuration may be included in, but is not limited to, a common serving cell configuration (or the ServingCellConfigCommon IE), a serving cell configuration (or the ServingCellConfig IE), a PUSCH serving cell configuration (or the PUSCH-ServingCellConfig IE), or a PDSCH serving cell configuration (or the PDSCH-ServingCellConfig IE).

The phrase “a specific configuration is per UL BWP or per BWP configured” or “a specific configuration is configured for a UL BWP or for a BWP” may mean that the specific configuration may be included in, but is not limited to, the BWP-Uplink IE, the BWP-UplinkDedicated IE, the BWP-UplinkCommon IE, the PUSCH-ConfigCommon IE, or the PUSCH-Config IE.

The phrase “a specific configuration is per DL BWP or per BWP configured” or “a specific configuration is configured for a DL BWP or for a BWP” may mean that the specific configuration may be included in, but is not limited to, the BWP-Downlink IE, the BWP-DownlinkDedicated IE, the BWP-DownlinkCommon IE, the PDSCH-ConfigCommon IE, or the PDSCH-Config IE.

The term “beam” may refer to spatial (domain) filtering. For example, the spatial filtering may be applied in the analog domain by adjusting the phase and/or amplitude of a signal before the signal is transmitted by an antenna element. In another example, the spatial filtering may be applied in the digital domain using the MIMO technique in wireless communication systems. For example, when a UE makes a PUSCH transmission using a specific beam, it means the UE is using a specific spatial or digital domain filter to perform the PUSCH transmission. Additionally, a beam may also refer to, but is not limited to, an antenna, an antenna port, an antenna element, a group of antennas, a group of antenna ports, or a group of antenna elements. A beam may be formed by a certain reference signal resource. A beam may be considered equivalent to a spatial domain filter that radiates electromagnetic waves.

The term “transmitted” in the present disclosure may be defined as the start, completion, or delivery of MAC CE/MAC PDU/LI signaling/higher layer signaling to the corresponding HARQ process/buffer for transmission, etc. The term “transmitted” may also refer to the reception of a HARQ_ACK feedback (e.g., a response from the gNB) for the MAC PDU carrying the MAC CE/MAC PDU/layer 1 signaling/higher layer signaling, etc. The term “transmitted” may also refer to the construction of the MAC CE/MAC PDU. The “HARQ_ACK feedback” may be implemented as a DCI format 0_0, 0_1, or another format received by the UE from the base station (e.g., a gNB) on a PDCCH, containing an NDI set to a specific value (e.g., 1) and indicating a HARQ process ID matching the HARQ process of the MAC PDU (carrying the BFRQ MAC CE) transmission.

In the present disclosure, although the term “gNB” is used throughout the document, it should be understood that the term “gNB” can be replaced by any other type of BS.

The PDCCH may be transmitted by the gNB to the UE, and the PDSCH may also be transmitted by the gNB to the UE. The PUSCH may be transmitted by the UE to the gNB. That is, the PDCCH and PDSCH may be received by the UE from the gNB, and the PUSCH may be received by the gNB from the UE.

A PDSCH/PDSCH/PUSCH transmission may span multiple symbols in the time domain. The time duration of such a transmission (e.g., a PDSCH/PDSCH/PUSCH transmission) may refer to the interval from the start of the first symbol of the transmission to the end of the last symbol of the transmission.

The term “A and/or B and/or C” may refer to any combination of “A,” “B,” and “C,” including each element individually or any two or all three in combination.

The term “interrupt” may be interchangeable with “stop,” “cancel,” or “skip.”

The phrase “instruct the PHY to generate acknowledgement” may be equivalent to “instruct the PHY to perform HARQ-ACK feedback.”

The term “acknowledgement” may be interchangeable with “HARQ-ACK” or “HARQ-ACK feedback.”

The phrase “the UE may not need to perform the corresponding HARQ feedback” may refer to “the HARQ entity/HARQ process may not need to perform the corresponding HARQ feedback.”

The phrase “by specific Physical layer signaling” may include, but is not limited to:
By a specific format of DCI;
By a specific field of DCI;
By a specific field of DCI set to a specific value; or
By DCI with CRC bits scrambled with a specific RNTI.

In the present disclosure, a MAC timer may be configured by the RRC as indicated by the gNB. The UE may be configured with an initial value for the timer, and the unit for this value may be a frame, sub-frame, millisecond, sub-millisecond, slot, or symbol. The UE's MAC entity may start or restart the timer. For example, the UE's MAC entity may start or restart the timer when specific conditions are met.

The NR cellular wireless communication system was developed by the 3GPP as a key 5G mobile network. NR introduces several new mechanisms, making it stand out from current mobile networks (e.g., 3GPP LTE) in terms of performance, flexibility, scalability, and radio resource efficiency. NR supports various types of services in particular frequency ranges, including eMBB, URLLC, and mMTC. NR operates in at least two FRs, namely FR1 and FR2, each corresponding to specific frequency ranges.

In 3GPP Release 18, XR traffic is supported in the NR. The latency requirements for XR traffic in the RAN may be defined as the Packet Delay Budget (PDB) and/or the PDU Set Delay Budget (PSDB). The PDB is a time limit for a packet to be transmitted through the air from a gNB to a UE. The delay for a packet may be measured from when the packet arrives at the gNB to when the packet is successfully delivered to the UE. If the delay exceeds the specified PDB, the packet is considered to have violated the PDB. Otherwise, the packet is deemed successfully delivered. The PDB value may vary depending on different applications and traffic types. The PSDB is the time limit for all PDUs within the same PDU set to be transmitted from a gNB to a UE.

3GPP has introduced the concept of a PDU set. A PDU set is a group of packets (e.g., IP packets) that are interdependent and crucial for an application. An example of the PDU set is the packets of a video frame needed to decode the video. The PDU set may receive uniform QoS treatment within the NR. Given that each IP packet in an XR PDU set (e.g., for a video frame) depends on the others and must be received within the specified PDB, the concept of the PDU set implies that the IP packets should not be treated independently in the RAN.

To meet the strict delay requirements for the XR traffic in NR, the gNB may need to schedule DL data and allocate UL resources to the UE promptly. Since radio resources are limited, there is a potential to improve the utilization efficiency. However, in the current NR system, when a UE has data, ready for transmission, stored in its buffer, the UE may request UL resources without informing the gNB of the corresponding data delay information or PDB. Therefore, this UL resource request mechanism may need to be improved. According to the present disclosure, one way to enhance the efficiency is by making the gNB aware of the data delay information (e.g., PDB information). Once the gNB has this data delay information, the gNB/scheduler may be able to prioritize the transmission of data with shorter PDBs.

In the NR wireless communication system, if a UE lacks available UL resources for a specific data transmission, the UE may request the gNB to provide these UL resources. The UE may send a request to the gNB, and the gNB may then schedule a certain amount of UL resources for the UE. The UE may be in an RRC_CONNECTED state during this process. If the UE is in the RRC_CONNECTED state, the request may be transmitted on a PUSCH scheduled by a DG or a CG. If the UE is in the RRC_IDLE state or the RRC_INACTIVE state, the request may be transmitted on a PUSCH scheduled by an RAR or a preconfigured PUSCH associated with a PRACH, known as a 2-step RA. The DG may be indicated by the DCI transmitted by a gNB, for example, on a PDCCH. The DCI may be found by the UE on a PDCCH through a process called blind decoding. For the blind decoding process, the UE may be configured with a set of PDCCH candidates within one or more CORESETs. The set of PDCCH candidates for the UE to monitor may be defined in terms of a PDCCH search space set (or simply, a search space set).

A search space set may be categorized into two types: a CSS set or a USS set. That is, the UE may monitor the PDCCH candidates according to one or more configured search spaces sets to decode the possible PDCCH(s) transmitted by the gNB. A PDCCH may be found in the PDCCH candidates within the monitored search space sets. For example, the UE may monitor a set of PDCCH candidates in one or more CORESETs and/or one or more search spaces on a DL BWP (e.g., the active DL BWP on each activated serving cell or the initial BWP on a camped cell) configured with the PDCCH monitoring according to the corresponding search space sets. This monitoring may involve decoding each PDCCH candidate according to the monitored DCI format(s). The DCI, with CRC bits scrambled by a UE-specific RNTI (e.g., C-RNTI), may be carried by the PDCCH. The UE may find/decode the DCI by descrambling the CRC bits with the RNTI.

As discussed earlier, the UE may monitor PDCCH candidates within one or more CORESETs. A CORESET may be a specific radio resource indicated by the gNB through one or more configurations (e.g., an information element, such as the ControlResourceSet IE). The configuration(s) may be transmitted to the UE by the gNB via a broadcast SIB or through dedicated (unicast) signaling. Each CORESET has a defined width in both the frequency and time domains, as indicated by the ControlResourceSet IE. In the time domain, CORESETs may appear periodically, allocated by the gNB. The exact positions of the CORESETs in the time domain may be preconfigured by the gNB to the UE through an information element, such as the SearchSpace IE. Each ControlResourceSet IE may be identified with a CORESET ID carried by the ControlResourceSet IE. Similarly, each SearchSpace IE may be identified with a SearchSpace ID carried by the SearchSpace IE. Each configured SearchSpace IE may be associated with a ControlResourceSet IE, as indicated through the SearchSpaces IE. By providing the associated ControlResourceSet IE and SearchSpaces IE to the UE, the gNB indicates, to the UE, the CORESET for PDCCH monitoring. Each search space may be categorized as a CSS or a USS, as indicated by the gNB to the UE via the corresponding SearchSpace IE. The UE may be indicated with multiple search spaces, each applied by the gNB for a different purpose, such as one search space for random access and another search space for normal data transmission/reception assignment.

The UE may transmit a request to the gNB for the UL resource(s). This request, transmitted by the UE to the gNB, may represent a specific UL signal, which may be, but is not limited to, a CE of the MAC layer (or a “MAC CE”), as defined in 3GPP TS 38.321. The MAC CE may carry various types of information, each indicated by a specific field of the MAC CE. For example, the MAC CE may indicate the amount of UL resources expected by the UE through a particular type of field. In some implementations, the MAC CE may indicate the amount of data that is stored/buffered in one or more buffers in the UE and is ready for transmission, where the one or more buffers may be in implemented in the UE's MAC, RLC, and/or PDCP layers. The MAC CE that carries this indication, which may be referred to as a BSR MAC CE, may include one or more BSRs for a MAC entity of a UE. Each BSR may indicate the data buffered in an LCG (e.g., including a group of LCHs) in the UE. Typically, a UE may be configured by the gNB via RRC signaling with more than one LCH, and each LCH may be associated with a respective application or QoS flow. Each LCH may further be configured by the gNB via RRC signaling to belong to an LCG. In NR, a UE may have up to 32 LCHs and up to 8 LCGs.

Depending on the number of BSRs that need to be transmitted by a UE, different formats of the BSR MAC CE may be used. The formats for BSR may include Short BSR format (fixed size), Long BSR format (variable size), Short Truncated BSR format (fixed size), and Long Truncated BSR format (variable size). The fields within the BSR MAC CE may be provided as follows:
LCG ID: The Logical Channel Group ID field identifies the group of LCHs the buffer status of which is being reported.
LCGi: For the Long BSR format, this field indicates the presence of the buffer size field for the i-th LCG (or “LCG i”) in the BSR MAC CE. If the LCGi field is set to a first value (e.g., 1), it means that the buffer size field for the LCG i is reported in the BSR MAC CE. If the LCGi field is set to a second value (e.g., 0), it means that the buffer size field for the LCG i is not reported. For the Long Truncated BSR format, the LCGi field indicates whether the LCG i has data available for transmission. If the LCGi field is set to a first value (e.g., 1), it means that the LCG i has data available for transmission in. If set to a second value (e.g., 0), it means that the LCG i has no data available for transmission.
Buffer Size: The value of the buffer size field (or buffer size value) may indicate the total amount of data available for transmission across all LCHs of a LCG after the MAC PDU has been built (e.g., after the logical channel prioritization procedure, which may reset the value of the buffer size field to zero). The amount of data may be indicated in bytes. The size of the RLC headers and MAC sub-headers may not be included in the buffer size calculation. The length of this field may vary in different BSR formats. The values for the buffer size fields may be mapped to different buffer size levels, depending on the length of this field. For both the Long BSR format and the Long Truncated BSR format, the buffer size fields may be included in ascending order based on the LCGi field.

In the present disclosure, one or more mechanisms for allowing the gNB to obtain data delay information from the UE (e.g., to enhance the gNB's scheduler to be delay-aware) are provided. These mechanisms may include the UE reporting the data delay information (e.g., for a specific data packet/LCH/LCG) to the BS (e.g., gNB) via UL signaling. The specific data packet may be the data that is ready for transmission and is stored in the buffer of the UE. The data delay information may include a PDB value and/or a remaining time value. The PDB value may indicate or represent a value of a PDB. The remaining time value may indicate or represent the remaining time before a packet violates its corresponding PDB. In some implementations, the PDB refers to an upper bound for the time that a packet may be delayed (e.g., the maximum allowed delay time) between the UE and the UPF that terminates the N6 interface (e.g., a reference point between the UPF and a data network). The PDB (value) may include two components: the AN-PDB (value) and the CN-PDB (value). The AN-PDB is the upper limit for the delay in the AN, and the CN-PDB is the upper limit for the delay in the CN.

The date delay information reported by the UE to the gNB for the corresponding data may be represented, as either the AN-PDB or CN-PDB. In the present disclosure, unless otherwise specified, the term “PDB” or “PDB value” may refer to an AN-PDB (value). Additionally, the terms “data delay information” and “delay information” may be used interchangeably in the present disclosure.

The data delay information reported to the gNB may be carried by a (UL) MAC CE. For example, the MAC CE carrying the data delay information may be a newly introduced MAC CE (e.g., “DR MAC CE”), a legacy BSR MAC CE, or an enhanced BSR MAC CE. The legacy BSR MAC CE may not contain any information about the delay. Therefore, if the UE needs to report the data delay information to the gNB via the legacy BSR MAC CE, the content, field, and/or format of the legacy BSR MAC CE may need to be modified or enhanced. The enhanced BSR MAC CE may contain one or more fields indicating data delay information. For example, the enhanced BSR MAC CE may include not only the LCG ID, LCGi, and/or buffer size fields, but also one or more newly defined fields. These newly defined fields may be used by the UE to indicate to the gNB the data delay information. The enhanced BSR MAC CE may also be considered, as a specific type of the newly introduced MAC CE. In some implementations, the newly defined field(s) may also be presented in the DR MAC CE.

When the UE reports data delay information via a MAC CE (e.g., the enhanced BSR MAC CE or the DR MAC CE), there may be several consideration factors. Firstly, to additionally carry data delay information in the MAC CE, the size of the MAC CE may need to increase, resulting in consuming more UL resources granted by the gNB. Therefore, it may be challenging to keep the MAC CE size compact, while providing accurate delay information to the gNB. Secondly, a UE may be configured with multiple LCHs, each associated with a different application or QoS flow. For example, only some LCHs may be configured to be associated with XR applications (or other time-critical applications). In such cases, data delay information may only be reported by the UE for those specific LCHs. The remaining LCHs, associated with non-XR (or non-time-critical) applications and not having the PDU set characteristic, may present a challenge in reporting data delay information and buffer size information simultaneously, for example, via a MAC CE. It may also be challenging for the gNB to identify with which LCH the data delay information carried by the MAC CE is associated.

### Delay Information to be Reported by a UE

In the present disclosure, various implementations are provided to address the above-identified challenges. For example, a MAC CE may include at least one new type of field (e.g., Delay Information (DI) field). The value indicated by the DI field may be associated with the data delay information. By including one or more DI fields in the MAC CE, the UE may be able to report data delay information to the gNB. In some implementations, the association between the value of the DI field and the data delay information may be based on one or multiple pre-defined or pre-configured mapping tables. The mapping table(s) may establish a correspondence (or relationship) between various values of the DI field and their corresponding data delay information values. In some implementations, the value of the DI field may directly refer to the data delay information value.

The following sub-sections (a) to (i) discuss various mechanisms of utilizing a MAC CE (e.g., an enhanced BSR MAC CE, a DR MAC CE, or any other newly introduced MAC CE) to report the data delay information. The UE may implement a combination of the various implementations as detailed in the sub-sections concurrently or choose to adopt the implementation(s) as described in any specific sub-section.
(a) In some implementations, the DI field in the MAC CE may include a bitmap. According to a corresponding mapping table, each value indicated by the DI field may indicate, represent, or be associated with, a data delay information value or a range of data delay information values.
(b) The UE may be configured with multiple mapping tables by the BS. The UE may determine which mapping table to apply based on at least one of the following factors: (1) the number of LCHs/LCGs that need to report the data delay information, and (2) the number of UL resources to be used for transmitting the MAC CE. In some implementations, if the UE is not configured by the BS with specific mapping tables, the UE may apply one or more pre-defined mapping tables. Determining which pre-defined mapping table is applied by the UE may be based on (1) the number of LCH/LCG needing to report data delay information and/or (2) the number of UL resources to be used for transmitting the MAC CE.
(c) In some implementations, the MAC CE may include one or more fields indicating whether the UE has data stored in the buffer for transmission and/or whether the data is urgent. Here, “urgent” may refer to the data's corresponding PDB value or a remaining time value reaching/exceeding a particular threshold, where the particular threshold may be a pre-defined value or pre-configured by the BS. In some implementations, the UE may indicate whether the data buffered in an LCH or an LCG is urgent through the MAC CE, with or without reporting detailed data delay information (e.g., the exact PDB value(s) and/or remaining time value(s)) to the BS. In some implementations, the UE may be configured with the particular threshold on a per LCG basis.
(d) In some implementations, the MAC CE may include more than one DI field. Each DI field may be associated with an LCH or an LCG. The LCG may be a group of LCHs configured for BSR reporting, or it may be an individual group of LCHs configured for data delay information reporting. In some implementations, a DI field associated with the i-th LCH (or LCH i) or the i-th LCG (or LCG i) may be denoted as DIi in the MAC CE.
(e) In some implementations, the MAC CE may include a presence indicator indicating whether a specific DI field for a specific LCH or LCG is included. For example, the presence indicator may include a field denoted as Presence of DIi (PDIi) that indicates whether the DIi field for an LCH i or an LCG i is included in the MAC CE. The PDIi may be set to a specific value (e.g., “1”) indicating that the DIi field for the LCH i or LCG i is included in the MAC CE, or set to another value (e.g., “0”) indicating that the DIi field is not included in the MAC CE.
(f) In some implementations, the definition of PDIi may vary depending on the format of the MAC CE. For example, if a specific type of MAC CE is used, for example, because the UE's UL resource is insufficient to carry the DI fields for all LCHs or LCGs that need to report the DI fields (e.g., the data delay information), the PDIi in this type of MAC CE may indicate whether an LCH i or LCG i has a corresponding DI field that needs to be reported.
(g) In some implementations, if the UE's UL resource is insufficient to carry the DI fields for all LCHs or LCGs that need to report the DI fields (e.g., the data delay information), or to carry both the DI fields and the buffer size fields for all LCHs or LCGs that need to report them, the UE may prioritize the transmission of the DI fields/data delay information values over the transmission of the buffer size fields. For example, a UE configured with eight LCGs (e.g., LCG 1, LCG 2, LCG 3, . . . , and LCG 8) may need to report the buffer size field for LCG 1, LCG 2, and LCG 3, and may need to report the data delay information value for LCG 1. If the UL resource is insufficient to transmit a MAC CE format that carries all the required buffer size fields and the data delay information value together, the UE may use another MAC CE format, which may be transmitted within the available UL resource. In such a scenario, the UE may set the LCGi fields for LCG 1, LCG 2, and LCG 3 (e.g., the fields LCG1, LCG2, and LCG3) to “1” to indicate to the gNB that LCG 1, LCG 2, and LCG 3 have the corresponding buffer size fields/values to be reported. If the MAC CE further includes the presence indicator, the UE may set the PDII field for LCG 1 to “1” to indicate to the gNB that LCG 1 has a corresponding data delay information value to be reported. Depending on the actual size of the alternate MAC CE format and considering the amount of UL resource available for transmission, the field DII may be prioritized over the buffer size fields for LCG 1, LCG 2, and LCG 3. In some implementations, the buffer size fields (e.g., for LCG 1, LCG 2, and LCG 3) may be included in the MAC CE in an ascending order based on the corresponding LCGi fields.
(h) In some implementations, the urgency of an LCG may be indicated by specifying a particular LCG ID.
(i) In some implementations, the UE may be configured or preconfigured with a mapping table that establishes a correspondence relationship between a list of indexes and a list of values. This list of values may define the combined information for both the data delay information values and the buffer size values.

### Determination of the Data Delay Information

As discussed above, a PDU set may include packets that are interdependent and may need to be decoded together. Each packet within an XR PDU set, such as a video frame, may depend on the others and need to be received within the expected PDB. For the DL XR traffic, the latency requirement of the XR traffic in the RAN side, specifically the air interface, may be modeled as PDB. The PDB (value) may represent the limited time budget (value) for a packet to be transmitted over the air from a gNB to a UE. For a specific packet, the delay incurred at the air interface may be measured from the time when the packet arrives at the gNB to the time when the packet is successfully transferred to the UE. If the delay exceeds the PDB for the packet, the packet violates the PDB. Conversely, if the delay does not exceed the PDB for the packet, then the packet is regarded as having been successfully delivered. For the UL XR traffic, the PDB may represent the limited time budget for transmitting a packet over the air from a UE to a gNB. Here, the delay may be measured from time when the packet arrives at the UE to the time when the packet is successfully transferred to the gNB. If the delay exceeds the PDB, the packet has violated the PDB, otherwise, if the delay does not exceed the PDB for the packet, then the packet may be regarded as having been successfully delivered.

In a BSR procedure, the buffer size value may be reported by the UE on a per LCG basis. For example, each reported buffer size value in the BSR MAC CE may represent the total amount of (UL) data packets buffered in all LCHs belonging to an LCG. To determine the buffer size value, the UE may perform a calculation, such as adding up the amount of data packets in each buffer associated with the LCHs belonging to an LCG. In the present disclosure, the data (or data packets) stored in the buffer(s) associated with the LCH(s)/LCG(s) may also be described as the data (or data packets) buffered in the LCH(s)/LCG(s).

A UE may identify a PDB by the upper layer, such as the application layer, and each packet stored in the buffer may have a respective PDB. In some implementations, the UE may determine the data delay information value (e.g., a PDB value or a remaining time value) to be included in the MAC CE on a per LCG basis. For example, the UE may determine the PDB value (or the remaining time value) for each LCG that is associated with the XR traffic (and/or other time-critical traffic) and may include at least one LCH having data stored in the buffer ready for transmission.

In some implementations, for an LCG that is associated with the XR traffic (and/or other time-critical traffic) and includes at least one LCH having data stored in the buffer ready for transmission, the UE may determine the data delay information value to be included in the MAC CE based on each data delay information value of the at least one LCH in the LCG. In some implementations, for the given LCG, the UE may choose to report the smallest value among the data delay information values of the at least one LCH in the LCG. For example, consider a situation where the UE is configured with four LCHs: LCH 1, LCH 2, LCH 3, and LCH 4, where LCH 1 and LCH 2 belong to LCG 1, LCH 3 and LCH 4 belong to LCG 2, and only LCH 1 and LCH 2 in these four LCHs are associated with the XR traffic (and/or other time-critical traffic). If the UE needs to report the buffer size value for LCG 1, and the data delay information value of the packets belonging to LCH 1 is x, while the data delay information value of the packets belonging to LCH 2 is y, the UE may choose to report either x or y as the data delay information value for LCG 1. In some implementations, in such a situation, the decision may involve selecting the smaller value between x and y. In another scenario, if there are multiple packets buffered in LCH 1 and LCH 2, and the data delay information value of the packets belonging to LCH 1 are x1 and x2, and those belonging to LCH 2 are y1 and y2, the UE may first select the smaller value between x1 and x2, and between y1 and y2. Thereafter, the UE may compare these two selected values and report the smaller one of the two, as the data delay information value for LCG 1. Specifically, in situations where an LCG includes one or more LCHs, each with a corresponding data delay information value, the UE may select the smallest value among the data delay information values as the data delay information value for the LCG, and may report the selected value as part of the data delay information in the MAC CE.

### BSR MAC CE Format Selection

A UE may be configured by the gNB through RRC signaling with multiple LCHs, and each LCH may be associated with a respective QoS flow. Each LCH may also be configured (e.g., by the gNB via RRC signaling) to belong to an LCG. If a BSR (procedure) is triggered, the UE may need to determine an appropriate format for the BSR MAC CE. This determination may involve determining which type of fields are to be included in the BSR MAC CE. In some implementations, the UE may also determine the value of each field by referring to one or more mapping tables. If at least one LCH is configured by the gNB to be associated with XR traffic and/or other time-critical traffic, the trigger for a BSR (procedure) may include whether there is a packet in the buffer whose PDB value or remaining time value matches certain conditions. In some implementations, if the data delay information value of at least one data packet buffered in an LCH/LCG exceeds a threshold (e.g., the data delay information value for a corresponding LCG is equal to or lower than the threshold), the UE may be triggered to report the data delay information. In some implementations, the threshold may be configured on a per LCG basis.

In some implementations, the triggering of reporting the data delay information may include triggering a specific type of BSR (procedure). In some implementations, if a MAC CE, which includes the buffer size field of a particular LCG, has been generated and transmitted by the UE, and if the data delay information value of at least one data packet in an LCH of the particular LCG exceeds a threshold (e.g., the data delay information value of the at least one data packet is equal to or lower than the threshold), a specific type of BSR (procedure) may be triggered.

In some implementations, the type of BSR MAC CE to be applied (also known as the type of fields to be included in the BSR MAC CE) may be determined by the UE based on at least one of the following factors: (1) the number of LCGs having data ready to be transmitted, (2) the number of specific LCHs/LCGs, where the data delay information value of the data buffered in these specific LCHs/LCGs exceeds the corresponding threshold(s), and (3) the number of UL resources available for transmitting the BSR MAC CE.

In some implementations, all BSRs triggered prior to MAC PDU assembly may be cancelled when a MAC PDU is transmitted. This PDU may include a Long BSR MAC CE, an Extended Long BSR MAC CE, a Short BSR MAC CE, or an Extended Short BSR MAC CE, which contains buffer status information up to (and including) the last event that triggered a BSR prior to the MAC PDU assembly.

It is noted that the PDB mentioned in the present disclosure may be replaced by PSDB in some implementations; the PDB value mentioned in the present disclosure may be replaced by PSDB value in some implementations.

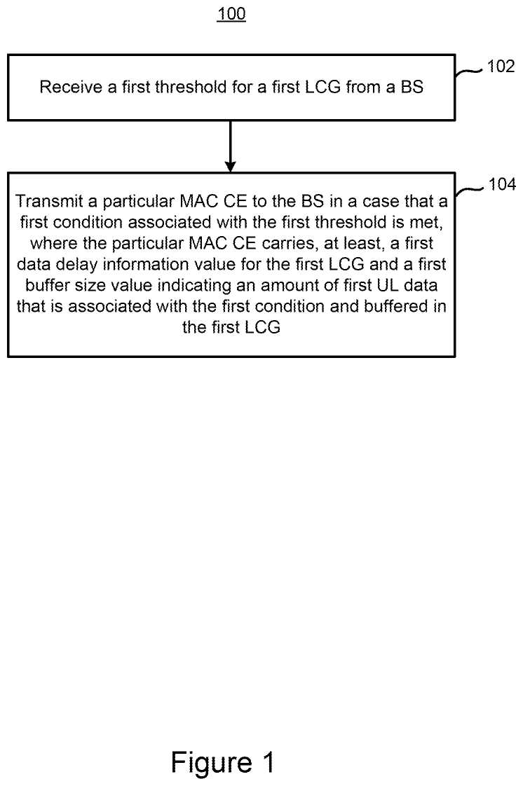

FIG. 1 is a flowchart of a method 100 for reporting data delay information in a wireless communication system, according to an example implementation of the present disclosure. It should be noted that although actions 102 and 104 are illustrated as separate actions, represented as independent blocks, in FIG. 1, these separately illustrated actions should not be construed as necessarily order-dependent. The order in which the actions are performed in FIG. 1 is not intended to be construed as a limitation, and any number of the disclosed blocks may be combined in any order to implement the method, or an alternate method. Moreover, each of actions 102 and 104 may be performed independently of other actions and may be omitted in some implementations of the present disclosure.

In action 102, a UE may receive a first threshold for a first LCG from a BS.

In action 104, the UE may transmit a particular MAC CE to the BS in a case that a first condition associated with the first threshold is met. The particular MAC CE may carry (or include), at least, a first data delay information value for the first LCG and a first buffer size value indicating an amount of first UL data that is associated with the first condition and buffered in the first LCG.

In some implementations, the first data delay information value may be represented by a PDB value or a remaining time value.

In some implementations, the first UL data may refer to the data originating from one or more LCHs within the first LCG that require the reporting of the data delay information. The association between the first UL data and the first condition may be established because the data delay information values from the LCH(s) in the first LCG, which require reporting of data delay information, may influence whether the first condition is met. For example, the first condition may include the first data delay information value being equal to or less than the first threshold. The first data delay information value may be selected from the data delay information values corresponding to the LCH(s) requiring reporting of data delay information.

In some implementations, the first LCG may be associated with time-critical traffic (e.g., XR traffic). The association of the first LCG with the time-critical traffic (e.g., XR traffic) may mean that the first LCG includes one or more LCHs that correspond to the time-critical traffic.

In some implementations, the particular MAC CE may further carry (or include) a presence indicator (e.g., the PDIi filed) indicating a presence of the first data delay information value in the particular MAC CE.

According to method 100, the UE transmits the data delay information value(s) and the corresponding buffer size value(s) on a per LCG basis via a particular MAC CE. This makes the process of reporting data delay information for time-critical traffic (e.g., XR traffic) more straightforward in wireless communication systems, leading to better resource use and meeting tight deadlines.

Furthermore, it should be noted that the UE may perform similar actions for each individual LCG, thereby reporting the data delay information on a per LCG basis. Additionally, the conditions for triggering the transmission of the particular MAC CE may also be determined on a per LCG basis. In such cases, the MAC CE may include respective data delay information values and buffer size values corresponding to different LCGs. For example, the UE may receive a second threshold for a second LCG from the BS and transmit the particular MAC CE to the BS further in a case that a second condition associated with the second threshold is met. The particular MAC CE may further carry (or include) a second data delay information value for the second LCG and a second buffer size value indicating an amount of second UL data that is associated with the second condition and buffered in the second LCG.

In some implementations, the UE may prioritize the transmission of the particular MAC CE over a transmission of a BSR MAC CE when the first condition or the second condition is met, where the BSR MAC CE include a third buffer size value indicating an amount of third UL data buffered in the first LCG or the second LCG. For example, the BSR MAC CE may be a legacy BSR MAC CE, which does not carry any data delay information (value). The prioritization by the UE allows the network to be informed about the data delay information more urgently, emphasizing the need for timely data transmission rather than just reporting buffer status. In some implementations, the UE may perform the prioritization in a case that the UL resource is insufficient to transmit both the particular MAC CE and the (legacy) BSR MAC CE.

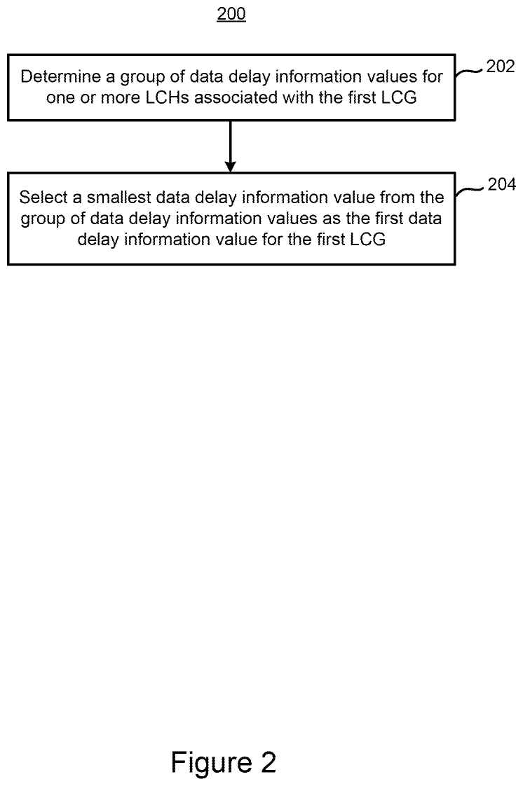

FIG. 2 is a flowchart of a method 200 for determining the first data delay information value for the first LCG, according to an example implementation of the present disclosure. Method 200 may be seen as either a continuation of the earlier mentioned methods, including method 100, with additional detailed actions for mobility enhancement, or as a standalone approach offering a different or more detailed way to enhance mobility. Moreover, method 200 may be integrated with method 100 and/or other methods described in the present disclosure. Additionally, method 200 uses terminology that is consistent with or corresponds to the terminology utilized in method 100.

In action 202, a UE may determine a group of data delay information values for one or more LCHs associated with (e.g., belonging to) the first LCG.

In action 204, the UE may select a smallest data delay information value from the group of data delay information values, as the first data delay information value for the first LCG.

The first UL data (e.g., as described in action 104 of FIG. 1) may be buffered in the one or more LCHs corresponding to the group of data delay information values from which the first data delay information value is selected.

Although method 200 mainly describes determining the first data delay information value for the first LCG, it should be noted that the UE may also apply a similar process to each individual LCG. That is, the UE may carry out actions similar to actions 202 and 204 for each LCG, thus determining the specific data delay information value for different LCGs. This method allows the UE to determine and choose the smallest data delay information value for each LCG, prioritizing the most urgent data in each LCG for transmission.

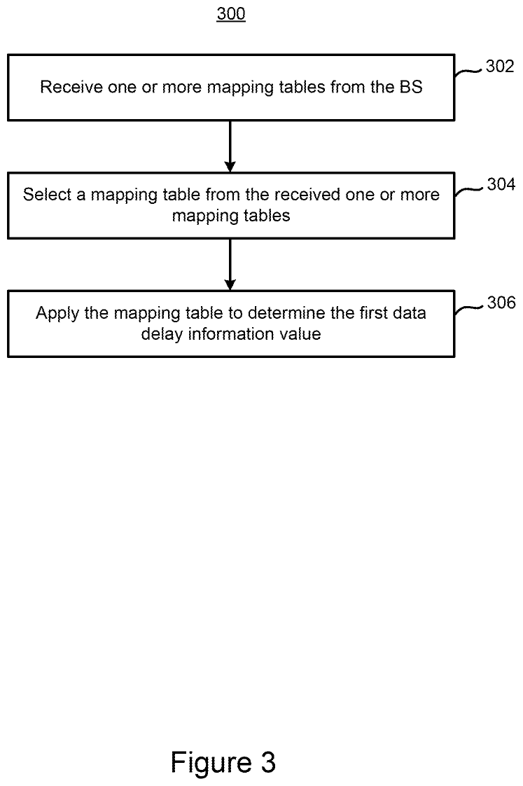

FIG. 3 is a flowchart of a method 300 for utilizing mapping table(s) to determine the first data delay information value, according to an example implementation of the present disclosure. according to an example implementation of the present disclosure. Method 300 may be seen as either a continuation of the earlier mentioned methods, including methods 100 and 200, with additional detailed actions for mobility enhancement, or as a standalone approach offering a different or more detailed way to enhance mobility. Moreover, method 300 may be integrated with method 100, 200, and/or other methods described in the present disclosure. Additionally, method 300 uses terminology that is consistent with or corresponds to the terminology utilized in method 100.

In action 302, a UE may receive one or more mapping tables from the BS.

In action 304, the UE may select a mapping table from the received one or more mapping tables. In some implementations, the UE may select the mapping table from the received one or more mapping tables according to at least one of: the number of LCGs for which the UE is required to trigger data delay information reporting and the number of UL resources to be used to transmit the particular MAC CE.

In action 306, the UE may apply the mapping table to determine the first data delay information value.

It should be noted that in the present disclosure, the BS may perform methods/actions corresponding to those performed by the UE. For example, the receiving actions performed by the UE may correspond to the transmitting/configuring actions of the BS; the transmitting actions performed by the UE may correspond to the receiving actions of the BS. That is, the BS and the UE may have reciprocally aligned roles in transmission and reception. Furthermore, for certain operations, both the UE and the BS may have a mutual understanding of the timer operations. For example, the BS may anticipate, expect, or determine when the UE starts a timer and when the timer is expected to expire or stop. This synchronized understanding allows for coordinated actions, ensuring that the network and UE are in sync for critical operations, such as handover or reconfiguration.

For example, when viewed from the BS's perspective, method 100 in FIG. 1 may correspond to a method performed by a BS for managing data delay information in a wireless communication system. The BS may transmit a first threshold for a first LCG to a UE, enabling the UE to transmit a particular MAC CE in a case that a first condition associated with the first threshold is met. The BS may receive the particular MAC CE from the UE, where the particular MAC CE may carry (or include) a first data delay information value for the first LCG and a first buffer size value indicating an amount of first UL data that is associated with the first condition and buffered in the first LCG. In some implementations, the first LCG may be associated with XR traffic. In some implementations, the particular MAC CE may further carry (or include) a presence indicator indicating a presence of the first data delay information value in the particular MAC CE.

In some implementations, the BS may further transmit a second threshold for a second LCG to the BS, enabling the UE to transmit the particular MAC CE further in a case that a second condition associated with the second threshold is met, where the particular MAC CE may further carry (or include) a second data delay information value for the second LCG and a second buffer size value indicating an amount of second UL data that is associated with the second condition and buffered in the second LCG.

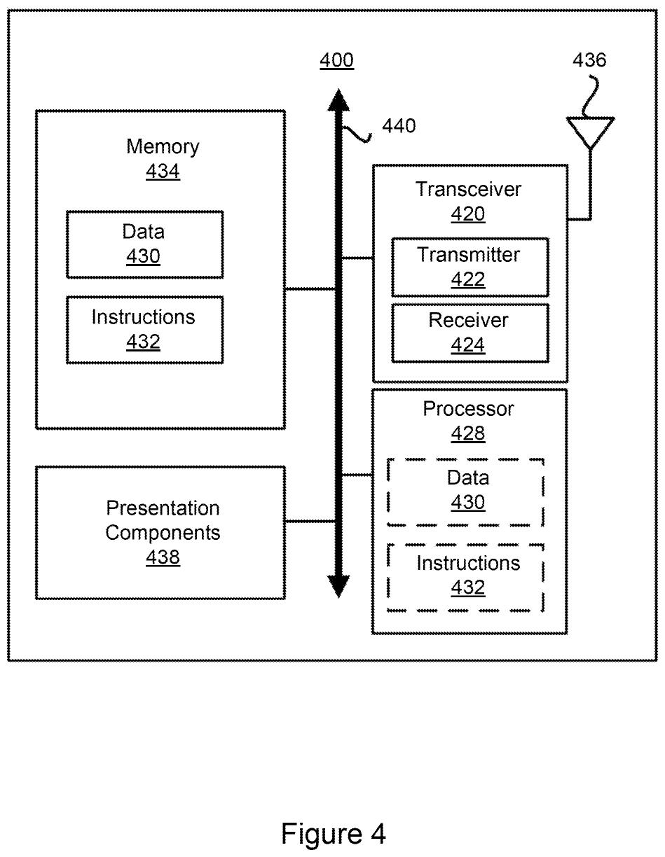

FIG. 4 is a block diagram illustrating a node 400 for wireless communications, in accordance with various aspects of the present disclosure. As illustrated in FIG. 4, node 400 may include transceiver 420, processor 428, memory 434, one or more presentation components 438, and at least one antenna 436. Node 400 may also include a radio frequency (RF) spectrum band module, a BS communications module, a network communications module, and a system communications management module, Input/Output (I/O) ports, I/O components, and a power supply (not illustrated in FIG. 4).

Each of the components may directly or indirectly communicate with each other over one or more buses 440. Node 400 may be a UE or a BS that performs various functions disclosed with reference to FIGS. 1 through 3.

Transceiver 420 has transmitter 422 (e.g., transmitting/transmission circuitry) and receiver 424 (e.g., receiving/reception circuitry) and may be configured to transmit and/or receive time and/or frequency resource partitioning information. Transceiver 420 may be configured to transmit in different types of subframes and slots including, but not limited to, usable, non-usable, and flexibly usable subframes and slot formats. Transceiver 420 may be configured to receive data and control channels.

Node 400 may include a variety of computer-readable media. Computer-readable media may be any available media that may be accessed by node 400 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

Memory 434 may include computer-storage media in the form of volatile and/or non-volatile memory. Memory 434 may be removable, non-removable, or a combination thereof. Example memory may include solid-state memory, hard drives, optical-disc drives, etc. As illustrated in FIG. 4, memory 434 may store a computer-readable and/or computer-executable instructions 432 (e.g., software codes) that are configured to, when executed, cause processor 428 to perform various functions disclosed herein, for example, with reference to FIGS. 1 through 3. Alternatively, instructions 432 may not be directly executable by processor 428 but may be configured to cause node 400 (e.g., when compiled and executed) to perform various functions disclosed herein.

Processor 428 (e.g., having processing circuitry) may include an intelligent hardware device, e.g., a Central Processing Unit (CPU), a microcontroller, an ASIC, etc. Processor 428 may include memory. Processor 428 may process data 430 and instructions 432 received from memory 434, and information transmitted and received via transceiver 420, the baseband communications module, and/or the network communications module. Processor 428 may also process information to send to transceiver 420 for transmission via antenna 436 to the network communications module for transmission to a CN.

One or more presentation components 438 may present data indications to a person or another device. Examples of presentation components 438 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A method performed by a User Equipment (UE) for reporting data delay information, the method comprising:
receiving a first threshold for a first Logical Channel Group (LCG) from a Base Station (BS); and
transmitting a particular Medium Access Control (MAC) Control Element (CE) to the BS in a case that a first condition associated with the first threshold is met,
wherein the particular MAC CE carries, at least, a first data delay information value for the first LCG and a first buffer size value indicating an amount of first Uplink (UL) data that is associated with the first condition and buffered in the first LCG.

2. The method of claim 1, further comprising:
determining a group of data delay information values for one or more Logical Channels (LCHs) associated with the first LCG; and
selecting a smallest data delay information value from the group of data delay information values as the first data delay information value for the first LCG.

3. The method of claim 2, wherein the first UL data is buffered in the one or more LCHs corresponding to the group of data delay information values from which the first data delay information value is selected, and the first condition comprises:
the first data delay information value being equal to or less than the first threshold.

4. The method of claim 1, further comprising:
receiving a second threshold for a second LCG from the BS; and
transmitting the particular MAC CE to the BS further in a case that a second condition associated with the second threshold is met,
wherein the particular MAC CE further carries a second data delay information value for the second LCG and a second buffer size value indicating an amount of second UL data that is associated with the second condition and buffered in the second LCG.

5. The method of claim 4, further comprising:
prioritizing the transmission of the particular MAC CE over a transmission of a Buffer Status Report (BSR) MAC CE when the first condition or the second condition is met,
wherein the BSR MAC CE comprises a third buffer size value indicating an amount of third UL data buffered in the first LCG or the second LCG.

6. The method of claim 1, further comprising:
receiving one or more mapping tables from the BS;
selecting a mapping table from the one or more mapping tables; and
applying the mapping table to determine the first data delay information value.

7. The method of claim 6, wherein selecting the mapping table from the one or more mapping tables comprises:
selecting the mapping table from the one or more mapping tables according to at least one of:
a number of LCGs for which the UE is required to trigger data delay information reporting, and
a number of UL resources to be used to transmit the particular MAC CE.

8. The method of claim 1, wherein the first LCG is associated with extended Reality (XR) traffic.

9. The method of claim 1, wherein the particular MAC CE further carries a presence indicator indicating a presence of the first data delay information value in the particular MAC CE.

10. A User Equipment (UE) for reporting data delay information, the UE comprising:
at least one processor; and
at least one memory coupled to the at least one processor, the at least one memory storing one or more computer-executable instructions that, when executed by the at least one processor, cause the UE to:
receive a first threshold for a first Logical Channel Group (LCG) from a Base Station (BS); and
transmit a particular Medium Access Control (MAC) Control Element (CE) to the BS in a case that a first condition associated with the first threshold is met,
wherein the particular MAC CE carries, at least, a first data delay information value for the first LCG and a first buffer size value indicating an amount of first Uplink (UL) data that is associated with the first condition and buffered in the first LCG.

11. The UE of claim 10, wherein the one or more computer-executable instructions, when executed by the at least one processor, further cause the UE to:
determine a group of data delay information values for one or more Logical Channels (LCHs) associated with the first LCG; and
select a smallest data delay information value from the group of data delay information values as the first data delay information value for the first LCG.

12. The UE of claim 11, wherein the first UL data is buffered in the one or more LCHs corresponding to the group of data delay information values from which the first data delay information value is selected, and the first condition comprises:
the first data delay information value being equal to or less than the first threshold.

13. The UE of claim 10, wherein the one or more computer-executable instructions, when executed by the at least one processor, further cause the UE to:
receive a second threshold for a second LCG from the BS; and
transmit the particular MAC CE to the BS further in a case that a second condition associated with the second threshold is met,
wherein the particular MAC CE further carries a second data delay information value for the second LCG and a second buffer size value indicating an amount of second UL data that is associated with the second condition and buffered in the second LCG.

14. The UE of claim 13, wherein the one or more computer-executable instructions, when executed by the at least one processor, further cause the UE to:
prioritize the transmission of the particular MAC CE over a transmission of a Buffer Status Report (BSR) MAC CE when the first condition or the second condition is met,
wherein the BSR MAC CE comprises a third buffer size value indicating an amount of third UL data buffered in the first LCG or the second LCG.

15. The UE of claim 10, wherein the one or more computer-executable instructions, when executed by the at least one processor, further cause the UE to:
receive one or more mapping tables from the BS;
select a mapping table from the one or more mapping tables; and
apply the mapping table to determine the first data delay information value.

16. The UE of claim 15, wherein selecting the mapping table from the one or more mapping tables comprises:
selecting the mapping table from the one or more mapping tables according to at least one of:
a number of LCGs for which the UE is required to trigger data delay information reporting, and
a number of UL resources to be used to transmit the particular MAC CE.

17. The UE of claim 10, wherein the first LCG is associated with extended Reality (XR) traffic.

18. The UE of claim 10, wherein the particular MAC CE further carries a presence indicator indicating a presence of the first data delay information value in the particular MAC CE.

19. A Base Station (BS) for managing data delay information in a wireless communication system, the BS comprising:
at least one processor; and
at least one memory coupled to the at least one processor, the at least one memory storing one or more computer-executable instructions that, when executed by the at least one processor, cause the BS to:
transmit a first threshold for a first Logical Channel Group (LCG) to a User Equipment (UE), enabling the UE to transmit a particular Medium Access Control (MAC) Control Element (CE) in a case that a first condition associated with the first threshold is met; and
receive the particular MAC CE from the UE,
wherein the particular MAC CE carries, at least, a first data delay information value for the first LCG and a first buffer size value indicating an amount of first Uplink (UL) data that is associated with the first condition and buffered in the first LCG.

20. The BS of claim 19, wherein the one or more computer-executable instructions, when executed by the at least one processor, further cause the BS to:
transmit a second threshold for a second LCG to the BS, enabling the UE to transmit the particular MAC CE further in a case that a second condition associated with the second threshold is met,
wherein the particular MAC CE further carries a second data delay information value for the second LCG and a second buffer size value indicating an amount of second UL data that is associated with the second condition and buffered in the second LCG.

21. The BS of claim 19, wherein the first LCG is associated with extended Reality (XR) traffic.

22. The BS of claim 19, wherein the particular MAC CE further carries a presence indicator indicating a presence of the first data delay information value in the particular MAC CE.
